(19) United States
(12) Patent Application Publication
(10) Pub. No.: US 2007/0191031 A1
(43) Pub. Date: Aug. 16, 2007

(54) Protocols for communication between paging controllers and paging agents during idle mode paging operations in a wireless network

(76) Inventors: Shantidev Mohanty, Hillsboro, OR (US); Muthaiah Venkatachalam, Beaverton, OR (US)

Correspondence Address: The Law Offices of John C. Scott, LLC;c/o PortfolioIP, P.O. Box 52050, Minneapolis, MN, 55402, US

(21) Appl. No.: 11/352,555

(22) Filed: Feb. 13, 2006

(51) Int. Cl. H04Q 7/20

(52) U.S. Cl. 455/458

(57) ABSTRACT

Protocols are provided to support communication between paging controllers and paging agents in a wireless network that implements idle mode paging.

### TECHNICAL FIELD

The invention relates generally to wireless networks and, more particularly, to techniques for performing idle mode paging in wireless networks.

### BACKGROUND OF THE INVENTION

Many wireless networking standards (e.g., IEEE 802.16, etc.) include an “idle mode” for wireless user devices that are not currently involved in active communication in a network. The idle mode is designed to reduce power consumption within the wireless user devices of a network. User devices within a network that are in idle mode are tracked by the network using paging and location update procedures. This paging may be used to, for example, determine the location of a particular user device in the network and to establish a call involving the user device. While in idle mode, a user device does not maintain a continuous active connection with the network. Instead, a paging cycle is established during which the device will occasionally wake up to listen for paging activity in the network. If paging commands are received by the device during this listening time, the user device may act in accordance with the commands. There is a need for techniques to manage idle mode operations in a wireless network in an efficient manner.

### BRIEF DESCRIPTION OF THE DRAWINGS

FIG. 1 is a diagram illustrating an example network arrangement that may implement features of the present invention;

FIG. 2 is a block diagram illustrating an example idle mode paging group that may exist within a network in accordance with an embodiment of the present invention;

FIG. 3 is a timing diagram illustrating an example paging cycle that may be used to manage paging operations for a mobile station in a network in accordance with an embodiment of the present invention;

FIG. 4 is an example signal flow diagram illustrating the flow of signals during a multicast paging operation in a wireless network in accordance with an embodiment of the present invention;

FIG. 5 is a signal diagram illustrating an example multicast packet format that may be used during communication between paging controllers and paging agents in a wireless network in accordance with an embodiment of the present invention;

FIG. 6 is a flowchart illustrating an example method that may be used to determine whether to use multicast or unicast transmission to perform multi-step paging in a wireless network in accordance with an embodiment of the present invention;

FIG. 7 is a flowchart illustrating an example method for use in performing idle mode paging within a wireless network in accordance with an embodiment of the present invention; and

FIG. 8 is a block diagram illustrating an example paging controller in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

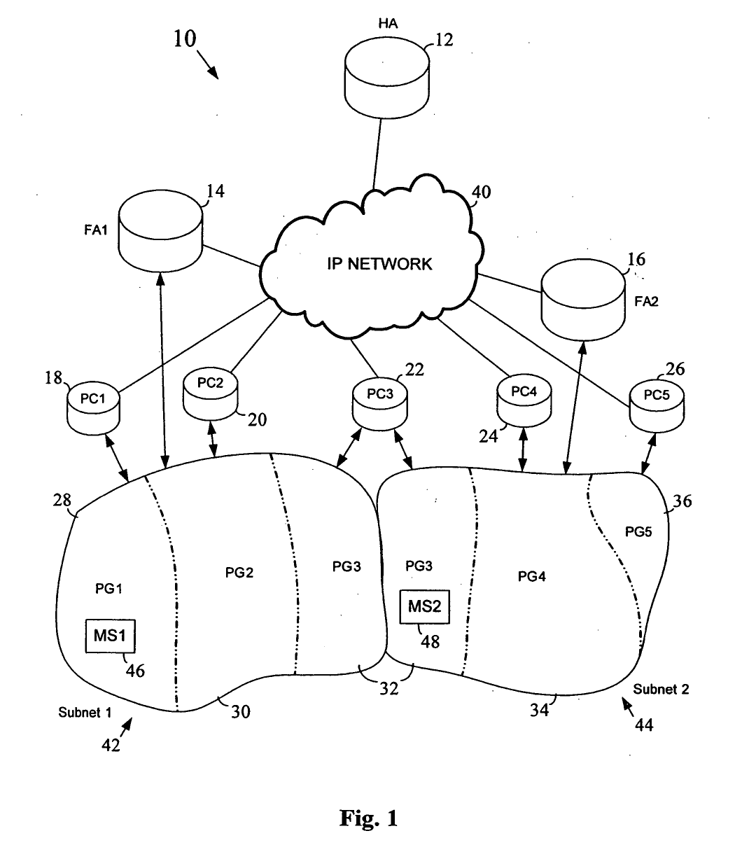

FIG. 1 is a diagram illustrating an example network arrangement 10 that may implement features of the present invention. As will be described in greater detail, the network arrangement 10 is capable of supporting idle mode operation for mobile stations (MSs) in the network that allows the MSs to enter a low power idle mode during periods of communication inactivity. In this manner, significant power savings may be achieved by the MSs as well as reductions in network traffic. When a MS is in idle mode, it is not capable of transmitting and receiving in a normal manner. Instead, paging techniques are used to provide communication between the idle mode MSs and the network. As shown in FIG. 1, the network arrangement 10 may include: a home agent (HA) 12; one or more foreign agents (FA1, FA2) 14, 16; one or more paging controllers 18, 20, 22, 24, 26 (PC1, PC2, PC3, PC4, PC5); and one or more paging groups 28, 30, 32, 34, 36 (PG1, PG2, PG3, PG4, PG5). The above-described elements may all be in communication with an IP network cloud 40. It should be appreciated that the network arrangement 10 of FIG. 1 is merely one example of a network configuration that may implement features of the present invention. Many other network topologies may alternatively be used.

The paging groups 28, 30, 32, 34, 36 are established in the network to provide, among other things, a coarse means to locate idle mode MSs in the network. Once the coarse location of the MS is known, it may be used to, for example, set up a new connection for the idle mode MS. The paging groups 28, 30, 32, 34, 36 in the network arrangement 10 may each include at least one wireless base station (BS) (not shown) to provide wireless network access for wireless mobile stations (MSs) in the group. Each base station in a paging group will have a corresponding coverage region or cell within which associated MSs will be located. The total geographic area covered by the BSs of a particular paging group may be referred to as the “paging area” of the group. The paging controllers 18, 20, 22, 24, 26 are operative for managing paging and idle mode operations for the paging groups 28, 30, 32, 34, 36. There will typically be one paging controller for each paging group. Thus, with reference to FIG. 1, PC 18 may manage paging operations for PG 28, PC 20 may manage paging operations for PG 30, and so on.

When an MS first goes into idle mode within a particular paging area, the corresponding PC chooses an anchor PC (which could be itself in some cases). This anchor PC in turn makes an entry in its database to indicate that the idle mode MS is in its paging group. As the idle mode MS moves about, the network keeps track of the paging group that the idle mode MS is currently within. This information may be reported back to the anchor PC, which may store the information for later use. Thus, the location of the idle mode MS will typically be known to within the granularity of one paging area. As will be described in greater detail, when a message is received in the network for a particular idle mode MS, the network first determines the current paging group of the MS and then causes a Mobile Paging Advertisement (MOB-PAG-ADV) message to be broadcast by some or all of the base stations of the paging group in an effort to locate the MS. When the MS receives the MOB-PAG-ADV, it may respond by transmitting a Mobile Paging Response (MOB-PAG-RSP) message to its associated base station. If warranted, the MS may then switch from idle mode to active mode to set up a connection with another entity in the network. As will be described in greater detail, the PC associated with the paging group that an idle mode MS is currently a member of, if not the anchor PC for the MS, may be used as a “relaying PC” to deliver a paging message to the MS.

As shown in FIG. 1, the BSs and MSs within the paging groups 28, 30, 32, 34, 36 may (or may not) be divided into multiple subnetworks 42, 44 (Subnet 1, Subnet 2) within the network arrangement 10. In the illustrated embodiment, each subnetwork 42, 44 includes multiple paging groups. That is, subnetwork 42 includes PG 28, PG 30, and a first portion of PG 32 and subnetwork 44 includes PG 34, PG 36, and a second portion of PG 32. In another possible topology, there may be a one to one relationship between subnetworks and paging groups. In still another, there may be multiple subnets within a single paging group or one subnet may overlap multiple PGs. Other topological relationships between PGs and subnets are also possible.

The home agent (HA) 12 is a network entity that may be assigned to receive packets that are destined for a particular MS (hereinafter, the “MS of interest”). That is, all packets that are addressed to the MS of interest may first be received by the HA 12. After reception of a packet for the MS of interest, the HA 12 may forward the packet to an appropriate foreign agent (FA) (e.g., FA 14 or FA 16) for the MS of interest using mobile IP address binding that is present in its database. Each of the FAs 14, 16 may be assigned to manage a corresponding subnet 42, 44 in the network 10. When the appropriate FA receives a packet for an MS of interest, it determines the anchor PC for the MS of interest and informs the anchor PC of the incoming data for the MS of interest. The anchor PC then attempts to locate the MS of interest so that a paging announcement message can be delivered thereto.

If the MS of interest is currently part of the paging group of its anchor PC, then the anchor PC may deliver the paging announcement message directly to some or all of the base stations of the paging group. The base stations receiving the paging announcement message may then broadcast the announcement within their respective cells. If the MS of interest is not currently part of the paging group of the anchor PC, then the technique for delivering the paging announcement message to the MS of interest may depend upon whether the anchor PC is “topologically aware” or “topologically unaware” of the paging area where the MS of interest is currently residing. A topologically aware anchor PC will have information about the make up of the paging group having the MS of interest. This information may include, for example, the identities of the BSs of the paging group. A topologically unaware anchor PC will not have specific information about the make up of the paging group having the MS of interest, but it will know of one or more relay PCs that may be used to relay the paging announcement to the paging area of the MS of interest. If the anchor PC is topologically aware, the anchor PC may deliver the paging announcement message directly to some or all of the base stations of the current paging group of the MS of interest. If the anchor PC is topologically unaware, then the anchor PC may have to deliver the paging announcement through one or more relay PCs. One of the relay PCs may then deliver the paging announcement message to some or all of the base stations in the paging group of the MS of interest, for broadcast. If desired, a topologically aware PC may send a paging announcement message through one or more relay PCs, rather than directly to the relevant BSs.

As shown in FIG. 1, paging group 28 (PG1) includes an idle mode MS 46 (MS1) within its paging area and paging group 32 (PG3) includes an idle mode MS 48 (MS2) within its paging area. Assume that HA 12 has FA 14 (FA1) as the foreign agent of MS 46 (MS1) and FA 16 (FA2) as the foreign agent of MS 48 (MS2) in its mobility binding database. Therefore, when packets arrive for MS 46, HA 12 forwards the packets to FA 14 and when packets arrive for MS 48, HA 12 forwards those packets to FA 16. The anchor PC for MS 46 is PC 18 (PC1) and the anchor PC for MS 48 is PC 24 (PC4). When FA 14 receives packets for MS 46, it delivers a paging request message to anchor PC 18. When PC 18 receives the paging request message, it generates and transmits a paging announcement message to some of all of the BSs in PG 28. PC 18 is able to do this because it is knowledgeable about the topology of PG 28. On the other hand, when PC 24 receives a paging request message for MS 48, if it does not have the topological information about PG 32, it generates and sends a paging announcement message to PC 22, which acts as a relay PC. PC 22 then transmits the paging announcement message to some or all of the BSs in PG 32. If PC 24 is topologically aware of PG 32, then PC 24 can directly transmit the paging announcement message to some or all of the BSs in PG 32.

In the discussion above, one of the PCs in the network is used to deliver the paging announcement message to base stations within the current paging group of the MS of interest. In some instances, it may be desirable to transmit the announcement to all of the base stations in the paging group at the same time. This technique is referred to as single step paging. In other instances, it may be desirable to initially send the paging announcement to only some of the base stations in the paging group and then, if the MS of interest has not received the announcement, send the paging announcement to other base stations in the paging group. This can be repeated if necessary until the MS of interest is found. This technique is referred to as multi step paging. Either or both of these techniques may be used in embodiments of the invention.

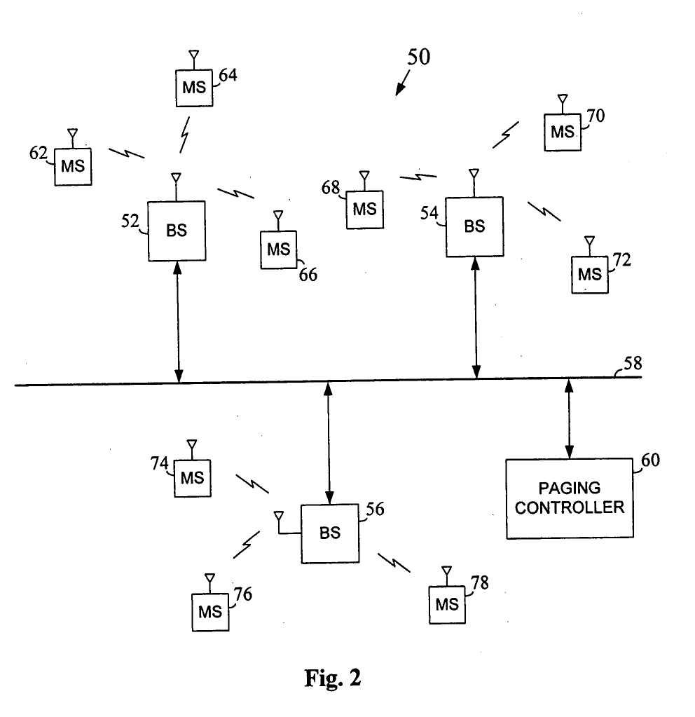

FIG. 2 is a block diagram illustrating an example idle mode paging group 50 that may exist within a network in accordance with an embodiment of the present invention. The paging group 50 may represent, for example, any of the paging groups 28, 30, 32, 34, 36 of FIG. 1. As shown, the paging group 50 includes three base stations 52, 54, 56 that are each coupled to a network backbone 58. A paging controller 60 associated with the paging group 50 is also coupled to the backbone 58. Each of the base stations 52, 54, 56 in the paging group 50 has one or more idle mode MSs associated with it. That is, base station 52 has associated idle mode MSs 62, 64, and 66, base station 54 has associated idle mode MSs 68, 70, and 72, and base station 56 has associated idle mode MSs 74, 76, and 78. Each of the base stations 52, 54, 56 may also have one or more active mode MSs (not shown) associated with it.

As described previously, when an MS of interest is currently within the paging group of its corresponding anchor PC, the anchor PC transmits a paging announcement message to some (for multi step paging) or all (for single step paging) of the base stations of the group. Thus, if paging controller 60 is the anchor PC for MS 66 during a paging operation for MS 66, then paging controller 60 may directly transmit the paging announcement message to base stations 52, 54, and 56 (or a subset thereof) to be broadcast in corresponding cells. If paging controller 60 is not the anchor PC for MS 66, then the anchor PC can still transmit the paging announcement directly to base stations 52, 54, and 56 (or a subset thereof) if it is topologically aware of paging group 50. Otherwise, the anchor PC will have to use PC 60 as a relay PC to transmit the paging announcement to base stations 52, 54, and 56 (or a subset thereof). It should be appreciated that any number of base stations (one or more) may be part of a paging group and the number of idle mode MSs associated with a particular base station may change with time.

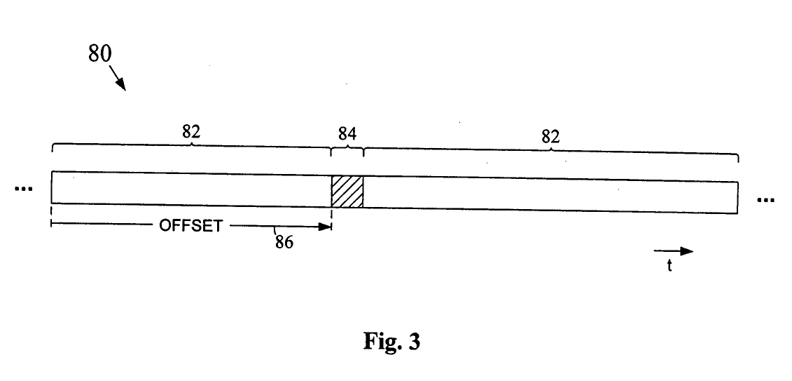

Paging operations for idle mode MSs are typically performed in paging cycles in a wireless network. FIG. 3 is a timing diagram illustrating an example paging cycle 80. As shown, the paging cycle 80 is divided into a paging unavailable interval 82 and a paging listening interval 84. During the paging unavailable interval 82, the MS is unavailable to the network. That is, the MS is in a low power state and is not capable of receiving or transmitting messages. During the paging listening interval 84, on the other hand, the MS listens for paging messages that are directed to it and, when detected, can respond to the messages. The paging listening interval 84 is usually of fixed duration and may be located anywhere within the paging cycle 80. The location of the paging listening interval 84 may be identified by a paging offset value 86 (measured from the beginning of the cycle 80). The numerical values of paging cycle duration, paging listening interval duration, and paging offset may all be negotiated between a user and the BS (or PC) during idle mode initiation. The paging cycle 80 will continuously repeat for each idle mode MS. The paging offset value 86 will typically be a constant for all idle mode MSs within a paging group.

In one aspect of the present invention, IP (internet protocol) multicasting techniques are used to provide communication between paging controllers and paging agents (e.g., base stations) in a network. IP multicasting involves sending a single message from a source node in a network to a plurality of destination nodes. Typically, a unique IP address is assigned to a predetermined group of communication nodes in the network. A message may then be delivered to that IP address and every node that is a part of the group is able to read the message. In the discussion above, it was established that a paging controller (either an anchor PC or a relay PC) may be called upon to transmit a paging announcement message to the base stations of a paging group when a message is received for an MS of interest within the paging group. In at least one embodiment of the invention, this paging announcement message is transmitted by the PC as a multicast transmission. In some embodiments, multicast transmissions may also be made by the paging agents themselves during paging operations. For example, a BS that locates an MS of interest in its coverage area during a paging operation may multicast a paging success message to other BSs in its paging group to inform the other BSs of the success. Upon receipt of the paging success message, the other BSs may immediately cease paging activities for the MS of interest, thus reducing the bandwidth usage on the corresponding airlink.

To utilize IP multicasting during idle mode paging operations in a wireless network, a number of multicast groups needs to be formed and maintained in the network. Each of the multicast groups may be assigned a unique multicast address. A PC (anchor or relay) can then transmit a paging announcement message as an IP multicast to a corresponding multicast group when a paging operation is being performed. The multicast groups may be defined in a number of different ways. In a first possible approach, for example, one multicast group may be established for each of the paging groups in the network and include all of the base stations of the paging group as well as all of the anchor PCs in the network. This approach is only for use in networks that utilize topologically aware paging. In this approach, all of the anchor PCs will receive any paging success messages transmitted by a base station/paging agent upon successful paging of the MS of interest. In a second approach, each multicast group will include all of the BSs of a corresponding PG as well as one anchor PC. In this approach, there are N multicast groups for each paging group in the network, where N is the number of anchor PCs in the network. Thus, the overall number of multicast groups, and the number of IP addresses required, increases by a factor of N over the previous approach. This approach will, however, reduce the bandwidth usage during paging operations over the previous technique as the paging success message transmitted by a base station will only reach a single anchor PC. This approach is also limited to use in networks using topologically aware paging.

In a third possible approach, each multicast group will contain the BSs of a PG and the corresponding relay PC of the PG. Using this approach, the number of multicast groups will equal the number of paging groups. In addition, the relay PC of the PG is the only PC that receives the paging success message, thereby reducing bandwidth usage. This technique can be used in networks that support topologically unaware paging. In a fourth possible approach, each multicast group will include only the BSs of a corresponding paging group. Thus, as before, the number of multicast groups will equal the number of paging groups. In this approach, an anchor or relay PC can send a multicast message to the BSs of the appropriate paging group, but it will not be able to hear a paging success message multicast by one of the BSs upon successful paging. If there is a need for the PC to receive the paging success message, the base stations can be configured to send a unicast message to the appropriate PC when successful paging has been achieved. This technique is very generic and scaleable and can be used in networks that support either topologically aware or topologically unaware paging. The IEEE 802.16 wireless networking standard does not currently require the delivery of a paging success message to an anchor or relay PC. Other techniques for defining the multicast groups to be used during idle mode paging operations in a wireless network may alternatively be used. Whichever technique is used, the multicast groups will have to be continuously updated during network operation to reflect paging group changes, such as variations in the number and membership of the paging groups. In the discussion that follows, it will be assumed that the fourth approach described above is used to define the multicast groups.

Various procedures are defined within the Requests for Comments (RFCs) of the Internet Engineering Task Force (IETF) that may be used to perform various tasks associated with the present invention. For example, RFCs exist for procedures to create multicast groups, to allow entities (e.g., BSs, PCs, etc.) to join and leave multicast groups, to perform packet exchanges within multicast groups, and so on. These procedures may be used in various embodiments of the invention. Other procedures may alternatively be used. In at least one embodiment of the invention, the BSs in a multicast group use shortest path tree based multicast distribution tree for the transfer of multicast messages.

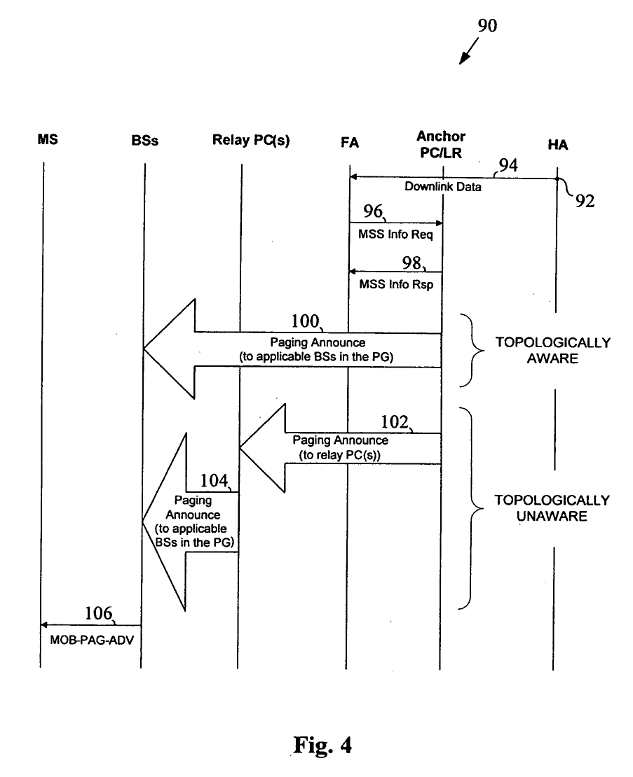

FIG. 4 is an example signal flow diagram illustrating the flow of signals during a multicast paging operation 90 in a network in accordance with an embodiment of the present invention. A data packet destined for an idle mode MS is first received by the home agent (HA) of the MS (point 92). The HA then forwards the packet 94 to the FA associated with the MS of interest using Mobile IP address binding that is present in a database of the HA. Upon receiving the packet, the FA learns that the MS is in idle mode. The FA then sends a Mobile Subscriber Station Information Request (MSS Info Req) message 96 to the anchor PC to initiate paging operations for the idle mode MS. The FA keeps track of the MS's anchor PC. Upon receiving the MSS Info Req message 96 for the idle mode MS, the anchor PC sends an MSS Information Response (MSS Info Rsp) 98 to the FA. The anchor PC retrieves the MS paging information from its location register (LR) and proceeds to construct a paging announcement message. The paging announcement message will typically include paging information for only one MS. However, if paging message aggregation is supported by the PC, the paging announcement message may include paging information for multiple MSs within the corresponding paging group.

The technique for transmitting the paging announcement message to the BSs may depend upon whether topologically aware paging is being implemented. If topologically aware paging is being implemented, then the paging announcement message may be transmitted as an IP multicast from the anchor PC to the applicable BSs of the PG 100. If single step paging is used, then the anchor PC will multicast the paging announcement message to all of the BSs of the PG. If multi step paging is used, then the anchor PC may initially multicast the paging announcement message to only a subset of the BSs of the PG. If the MS of interest is not found within that subset, then the paging announcement message may be multicast to another subset of BSs, and so on. This can be repeated until the MS of interest is found. An algorithm may be provided to decide which BSs will be paged during each step.

If topologically unaware paging is being used, then the paging announcement message may first be transmitted to one or more relay PCs 102. The final relay PC may then multicast the paging announcement message to the BSs of the PG 104. Single step or multi step paging may likewise be used when performing topologically unaware paging. After the BSs have received the paging announcement message, they may each broadcast a Mobile Paging Advertisement (MOB-PAG-ADV) message in a respective cell 106. If the MS of interest is in one of the paged cells, it will return a Mobile Paging Response (MOB-PAG-RSP) message to the corresponding BS. That base station may then multicast a paging success message.

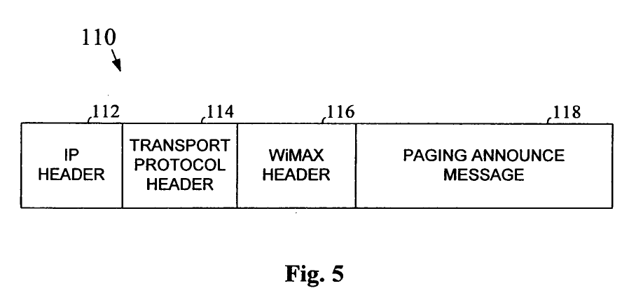

FIG. 5 is a signal diagram illustrating an example multicast packet format 110 that may be used during communication between paging controllers and paging agents in a wireless network in accordance with an embodiment of the present invention. As shown, the multicast packet format 110 may include: an IP header 112, a transport protocol header 114 (e.g., UDP, SCTP, etc.), a WiMAX header 116, and the paging announcement message 118. The IP header 112 may contain, among other things, the IP multicast address of the multicast group that is the subject of the current paging operation. The transport protocol header 114 may contain, for example, the source and destination port information and other transport protocol parameters. The WiMAX header 116 may contain header information specified by the IEEE 802.16 wireless networking standard. The paging announcement message 118 may include, for example, the ID of the specific MS being paged (or multiple IDs if aggregation is being used) and other relevant paging parameters (e.g., PAGING CYCLE, PAGING OFFSET, etc.). The multicast packet format 110 of FIG. 5 may be used by both anchor PCs and relay PCs to multicast paging signals to corresponding BSs. The multicast packet format 110 may also be used by base stations to multicast, for example, paging success messages, etc. Other packet formats may alternatively be used. For example, for wireless networks following standards other than IEEE 802.16, the protocol headers associated with the other standard may be used.

When multi step paging is being used, there are a number of ways that the IP multicasting may be implemented. In one approach, for example, multicast groups may be created on the fly for each subset of BSs associated with a paging group. Multicast paging may then be carried out for the newly created multicast groups using the techniques described previously. In another approach, new multicast groups are not generated. Instead, the paging announcement message is multicast to the address of the multicast group associated with the relevant paging group and the identities of the BSs that are currently being paged are included in the paging announce message portion of the packet (see, e.g., paging announce message 118 of FIG. 5). This can be implemented by, for example, using a flag to indicate whether a particular BS in the paging group is an intended recipient of the paging announcement message or not for the current step of the multi step paging. However, if the number of BSs in a PG is large, this approach can result in the generation of large sized paging announcement messages. If a paging announcement message is too large, then it may be more efficient to transmit a number of unicast paging announcements to the desired BSs.

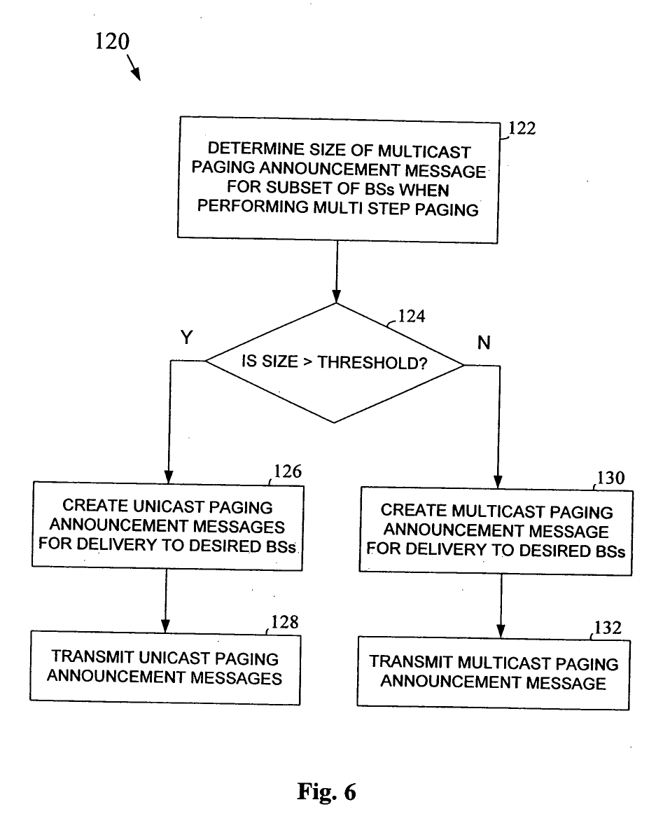

FIG. 6 is a flowchart illustrating an example method 120 to determine whether to use multicast or unicast transmission to perform multi step idle mode paging in a wireless network in accordance with an embodiment of the present invention. First, the size of a multicast paging announcement message is determined for a subset of BSs within a paging group that are to be paged (block 122). The multicast paging announcement message is to include some form of identification information for each of the BSs in the subset within the body of the message. The size of the message is next compared to a predetermined threshold value to determine whether the message is too large (block 124). If the message size is greater than the threshold size, then a number of unicast paging announcement messages are created for delivery to the desired BSs (block 126). The unicast paging announcement messages may then be transmitted to the desired BSs (block 128). If the message size is not greater than the threshold size, then a single multicast paging announcement message is created for delivery to the desired BSs (block 130). The multicast paging announcement message may then be transmitted to the desired BSs (block 132). Other techniques for deciding between unicast and multicast paging during multi step paging operations based on message size may alternatively be used.

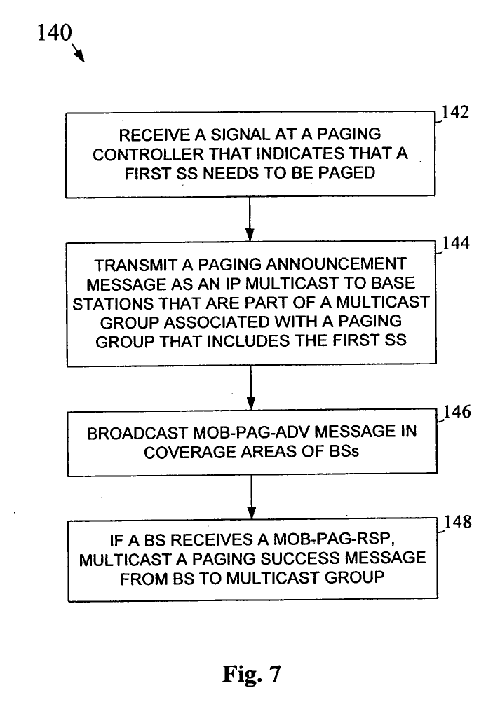

FIG. 7 is a flowchart illustrating an example method 140 for use in performing idle mode paging within a wireless network in accordance with an embodiment of the present invention. First, a signal is received at a paging controller that indicates that a first MS needs to be paged (block 142). The paging controller may be either an anchor PC (if topologically aware paging is being implemented) or a relay PC (if topologically unaware paging is being implemented). If the PC is an anchor PC, the received signal may be, for example, a paging request signal received from a foreign agent (FA). If the PC is a relay PC, the received signal may be, for example, a paging announcement message received from an anchor PC or another relay PC. A paging announcement message is then transmitted by the paging controller as an IP multicast to entities (base stations, etc.) that are part of a multicast group associated with a paging group that includes the first MS (block 144). The paging announcement message may be transmitted as a packet having the packet format of FIG. 5 or a similar format. As described above, the multicast groups may be defined in any of a number of different ways in the network. For example, each multicast group may include only the base stations of a corresponding paging group in the network, etc. Either single step paging or multistep paging may be used to transmit the paging announcement message to the members of the multicast group. The base stations that receive the paging announcement message may then each broadcast a MOB-PAG-ADV within a corresponding coverage area (block 146). In at least one implementation, if one of the base stations in the subject paging group subsequently receives a MOB-PAG-RSP message from the first MS, then the base station may multicast a paging success message to the multicast group (block 148). In this manner, other base stations in the multicast group can read the paging success message and cease all searching activities for the first MS (i.e., refrain from further broadcasting of the paging announcement message, etc.), thus reducing bandwidth usage within the network.

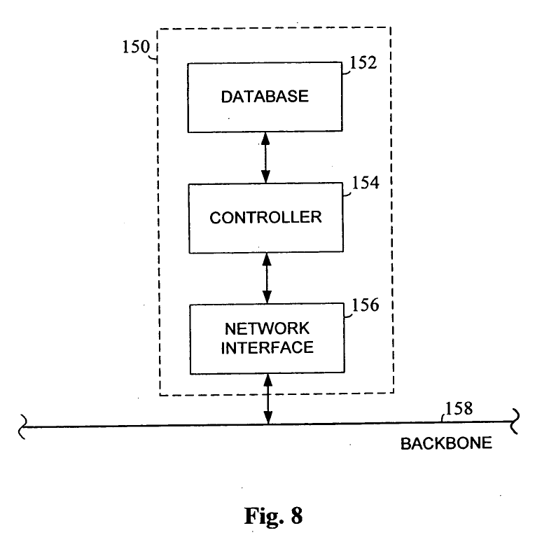

FIG. 8 is a block diagram illustrating an example PC 150 in accordance with an embodiment of the present invention. The PC 150 may be used as, for example, any one of the paging controllers 18, 20, 22, 24, 26 illustrated in FIG. 1. As shown, the PC 150 may include: a database 152, a controller 154, and a network interface 156. The controller 154 provides paging control functions for a paging group within an associated network. The network interface 156 provides an interface to a network medium, such as the network backbone 158 shown in FIG. 8. In other embodiments, the network interface 156 may be a wireless interface for interfacing with a wireless network medium. The database 152 stores paging related information that may be used by the controller 154 during paging operations in the network. The paging information may include, for example, information about a paging group associated with PC 150, information about other paging groups in the network, information about other PCs in the network, information about the location of idle mode MSs in the network, information about multicast group addresses in the network, and/or other paging related information. The controller 154 will typically include one or more digital processing devices that can be configured to perform the desired functions. The digital processing device(s) may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, including combinations of the above.

In at least one embodiment, the controller 154 may be configured to transmit a paging announcement message to paging agents (e.g., base stations, etc.) within a paging group associated with a MS of interest using IP multicast techniques. The controller 154 may generate the IP multicast packet that includes the IP address of the desired multicast group and cause the packet to be transmitted onto the network medium via the network interface 156. The PC 150 may operate as an anchor PC and/or as a relay PC. If the PC 150 is configured to support topologically aware paging, the database 152 may include detailed information about the contents of other paging groups (i.e., paging groups that are not associated with PC 150).

In at least one embodiment, the controller 154 may be adapted to perform multi step paging in addition to single step paging. Logic may be provided, for example, for determining which paging agents within a paging group are to be sent a paging announcement message during various phases of multi step paging process. The controller 154 may also include logic to determine whether to use multicast or unicast transmission during multi step paging operations based on multicast packet size (such as illustrated FIG. 6, for example). In at least one embodiment, the controller 154 may include logic to develop multicast groups on the fly during multi step paging operations. In other embodiments, the controller 154 may include logic to add identification information to the body of a multicast packet that identifies a subgroup of paging agents within a paging group that are to be paged by the packet during a multi step paging operation. In at least one embodiment, the controller 154 and the database 152 may be available as a separate chip, package, or module.

The various features of the present invention described above, either alone or in combination, may provide many advantages within an implementing network. For example, inventive features may be used to maintain the IP nature of an IP-based broadband wireless network. In embodiments that utilize a shortest path tree based multicast distribution tree, a minimal delay may be achieved in the transfer of messages between the members of a multicast group (e.g., the BSs of a PG, etc.). The use of IP multicasting may also minimize the number of packet copies on the network for paging operations, as it relies on the broadcast nature of Ethernet LANs in the backbone. The routers along the signal path in the network will typically make copies of the packet only when absolutely necessary, as opposed to multi-unicasting where copies are made at the source. Features of the invention may also be used to support dynamic configuration of PGs by using the join/leave primitives discussed previously. The proposed protocols may be used within networks implementing topologically aware and/or topologically unaware paging, single step and/or multi step paging, and user dependent and/or user independent paging.

In the discussion above, terminology is used that is often associated with the IEEE 802.16 wireless networking standard. It should be appreciated, however, that the inventive principles are not limited to use within IEEE 802.16 based networks. That is, features of the invention may be implemented within any network where paging of user devices is practiced, regardless of standard.

The techniques and structures of the present invention may be implemented in any of a variety of different forms. For example, features of the invention may be embodied within paging controllers; network servers; wireless base stations; wireless access points; laptop, palmtop, desktop, and tablet computers; network interface cards (NICs) and other network interface structures; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method comprising:
receiving a signal at a paging controller (PC) in a network that indicates that a first wireless mobile station (MS) in the network needs to be paged; and
transmitting a paging announcement message from the PC as an Internet Protocol (IP) multicast to a multicast group within the network that includes at least some of the base stations of a paging group in the network that includes said first MS.

2. The method of claim 1, wherein:
said PC is an anchor PC associated with said first wireless MS.

3. The method of claim 1, wherein:
said PC is a relay PC associated with said paging group that includes said first MS.

4. The method of claim 1, wherein:
said multicast group includes all of the base stations of said paging group that includes said first MS.

5. The method of claim 1, wherein:
said multicast group includes all of the base stations of said paging group that includes said first MS and all of the anchor paging controllers within the network.

6. The method of claim 1, wherein:
said multicast group includes all of the base stations of said paging group that includes said first MS and an anchor paging controller associated with said first MS.

7. The method of claim 1, wherein:
said multicast group includes all of the base stations of said paging group that includes said first MS and a relay paging controller associated with said paging group.

8. The method of claim 1, wherein:
said multicast group includes a subset of the base stations of said paging group that includes said first MS as part of a multi step paging process.

9. An apparatus comprising:
a controller to transmit an IP multicast packet including a paging announcement message to base stations within a paging group of a network when a mobile station (MS) within the paging group needs to be paged; and
a database, in communication with said controller, to store paging related information about said network.

10. The apparatus of claim 9, wherein:
said paging related information includes locations of idle mode MSs in the network.

11. The apparatus of claim 9, wherein:
said paging related information includes addresses of multicast groups in the network.

12. The apparatus of claim 9, wherein:
said IP multicast packet is to include a multicast group address of a multicast group that includes said base stations.

13. The apparatus of claim 12, wherein:
said multicast group includes all of the base stations within said paging group and no other members.

14. The apparatus of claim 12, wherein:
said multicast group includes all of the base stations within said paging group and all of the anchor paging controllers within said network.

15. The apparatus of claim 12, wherein:
said multicast group includes all of the base stations within said paging group and a single anchor paging controller associated with said mobile station.

16. The apparatus of claim 12, wherein:
said multicast group includes all of the base stations within said paging group and a single relay paging controller associated with said paging group.

17. The apparatus of claim 12, wherein:
said multicast group includes a subset of the base stations within said paging group for use during multi step paging.

18. The apparatus of claim 9, wherein:
said controller includes logic to insert identification information within a body of said IP multicast packet to identify a subset of base stations within said paging group that are to receive said IP multicast packet during multi step paging operations.

19. The apparatus of claim 9, wherein:
said controller includes logic to determine which base stations within a paging group are to be sent a paging announcement message during various phases of a multi step paging process.

20. The apparatus of claim 9, wherein:
said controller includes logic to determine whether to use multicast or unicast transmission during a multi step paging operation based on multicast packet size.

21. The apparatus of claim 9, wherein:
said controller includes logic to develop multicast groups on the fly during multi step paging operations.

22. A method comprising:
receiving a mobile paging response message from a mobile station of interest at a first base station during an idle mode page operation; and
transmitting a paging success message from said first base station, as a multicast IP packet, to a multicast group that includes multiple base stations within a common paging group as said first base station so that said multiple base stations can cease searching for said mobile station of interest.

23. The method of claim 22, wherein:
said multicast group includes all of the base stations of said common paging group.

24. The method of claim 22, wherein:
said multicast IP packet includes a multicast address of said multicast group in a header thereof.

25. A system comprising:
a controller to transmit an IP multicast packet including a paging announcement message to base stations within a paging group of a network when a mobile station within the paging group needs to be paged;
a database, in communication with said controller, to store paging related information about said network; and
a wired network interface to provide an interface with a wired network medium for said system.

26. The system of claim 25, wherein:
said controller includes logic to determine whether to use multicast or unicast transmission during multi step paging operations based on multicast packet size.

27. The system of claim 25, wherein:
said controller includes logic to develop multicast groups on the fly during multi step paging operations.

28. An article comprising a storage medium having instructions stored thereon that, when executed by a computing platform, operate to:
receive a signal at a paging controller (PC) in a network that indicates that a first wireless mobile station (MS) in the network needs to be paged; and
transmit a paging announcement message from the PC, as an Internet Protocol (IP) multicast packet, to a multicast group within the network that includes at least some of the base stations of a paging group in the network that includes said first MS.

29. The article of claim 28, wherein:
said PC is an anchor PC associated with said first wireless MS.

30. The article of claim 28, wherein:
said PC is a relay PC associated with said paging group that includes said first MS.
